(19) United States
(12) Patent Application Publication
(10) Pub. No.: US 2025/0182659 A1
(43) Pub. Date: Jun. 5, 2025

(54) POWER BASED CONTENT-AWARE ACTIVATION OF LIGHT EMITTING ELEMENT-BASED DISPLAYS

(71) Applicant: Meta Platforms Technologies, LLC, Menlo Park, CA (US)

(72) Inventors: Jean-Charles Bazin, Sunnyvale, CA (US); David Teitlebaum, Seattle, WA (US)

(21) Appl. No.: 18/525,290

(22) Filed: Nov. 30, 2023

(51) Int. Cl. G09G 3/00; G09G 3/32

(52) U.S. Cl. CPC G09G 3/002; G09G 3/003; G09G 3/32; G09G 2320/0247; G09G 2320/106; G09G 2330/021

(57) ABSTRACT

Power based content-aware activation of light emitting element-based displays is described. A heatmap is generated that corresponds to an image. The image is associated with a plurality of pixels that each corresponds to a different light emitting element of an array of light emitting elements of a display element, and the heatmap describes an importance level of each pixel of the image. For each light emitting element of the array of light emitting elements, a determination is made whether the light emitting element will be active or inactive based in part on the heatmap, one or more cost functions, and at least one power constraint to generate visual content. The display element may present the visual content.

### FIELD OF THE INVENTION

This disclosure relates generally to displays, and more specifically to power based content-aware activation of light emitting element-based displays.

### BACKGROUND

Artificial reality headsets typically have limited power budgets. The power budgets are such that once a low power threshold is reached, a conventional artificial reality headset typically stops displaying visual content (e.g., typically after some sort of low power warning). As such, conventional artificial reality headsets typically do not have means of extending how long their displays are active when available power for them drops below some threshold level.

### SUMMARY

Embodiments described herein relate to power based content aware activation of light emitting element based displays (e.g., display elements). Given a certain power budget, a determination is made regarding which of the light emitting elements are active (i.e., emit light) and which ones are inactive (i.e., do not emit light). The number of activated light emitting elements may be controlled to reduce the power usage while preserving the appearance of the content to be displayed. The content of the image to be displayed may be used to compute which light emitting elements are active and which light emitting elements are inactive for a given image frame. The optimization may also incorporate cost factors and/or constraints that can be adjusted based on different use cases and requirements.

In some embodiments a method is described. The method may include generating a heatmap corresponding to an image. The image is associated with a plurality of pixels that each corresponds to a different light emitting element of an array of light emitting elements of a display element, and the heatmap describes an importance level of each pixel of the image. The method may determine for each light emitting element of the array of light emitting elements whether it will be active or inactive using the heatmap, one or more cost functions, and at least one power constraint to generate visual content. The method may further instruct the display element to present the visual content.

In some embodiments a non-transitory computer-readable storage medium is described. The non-transitory computer-readable storage medium comprises stored instructions. The instructions when executed by a processor of a device, cause the device to: generate a heatmap corresponding to an image. The image is associated with a plurality of pixels that each corresponds to a different light emitting element of an array of light emitting elements of a display element, and the heatmap describes an importance level of each pixel of the image. The instructions further cause the device to determine for each light emitting element of the array of light emitting elements whether it will be active or inactive using the heatmap, one or more cost functions, and at least one power constraint to generate visual content. The instructions further cause the device to instruct the display element to present the visual content.

In some embodiments a system is described. The system includes a display element comprising an array of light emitting elements. The system further includes a display controller, and the display controller generates a heatmap corresponding to an image. The image is associated with a plurality of pixels that each corresponds to a different light emitting element of the array of light emitting elements, and the heatmap describes an importance level of each pixel of the image. The display controller may determine for each light emitting element of the array of light emitting elements whether it will be active or inactive using the heatmap, one or more cost functions, and at least one power constraint to generate visual content. The display controller may further instruct the display element to present the visual content.

### BRIEF DESCRIPTION OF THE DRAWINGS

FIG. 1A is a perspective view of a headset implemented as an eyewear device, in accordance with one or more embodiments.

FIG. 1B is a perspective view of a headset implemented as a head-mounted display, in accordance with one or more embodiments.

FIG. 2 is a block diagram of a display assembly, in accordance with one or more embodiments.

FIG. 3A illustrates an exemplary display assembly for presenting visual content of an image, in accordance with one or more embodiments.

FIG. 3B illustrates a heatmap corresponding to the image generated by the display assembly, in accordance with one or more embodiments.

FIG. 3C illustrates an activation of the light emitting elements based on the generated heatmap for presenting the image, in accordance with one or more embodiments.

FIG. 4 is a flowchart illustrating a process for controlling a display element for presenting visual content, in accordance with one or more embodiments.

FIG. 5 is a system that includes a headset, in accordance with one or more embodiments.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

A display uses light emitting elements which consumes power to present content. The more light emitting elements with high intensity are used, the more power is used, and thus the faster the battery of the device (e.g., VR/AR headsets) will run out. On one hand, if all the light emitting elements are not activated, the power saving is at the highest (zero power is used) but nothing is displayed. On the other hand, if all the light emitting elements are activated with high intensity, the content is “best” displayed but the power saving will be zero (maximum power usage) and the battery will run short quickly.

This disclosure relates power based content aware activation of light emitting elements based displays. In particular, the display reduces the number of activated light emitting elements to reduce the power usage while preserving the appearance of the content to be displayed. The display generates a heatmap corresponding to an image, which is associated with a plurality of pixel elements. Each pixel element corresponds to a different light emitting element of an array of light emitting elements of a display element, and the heatmap describes an importance level of each pixel element of the image. The display determines for each light emitting element of the array of light emitting elements whether it will be active or inactive using the heatmap, one or more cost functions, and at least one power constraint to generate visual content. The activated light emitting elements, while consuming power, present the corresponding pixel element of the image; and the inactivated light emitting elements, while not consuming power, do not present the corresponding visual content.

The content of the image to be displayed is used to compute which light emitting elements to activate. The display also uses a flexible framework that can be adjusted based on different use cases and requirements. The display computes a heatmap of an image based on the content of the image, and further incorporates cost factors and constraints to balance between the content preservation and the power usage. In this way, the display preserves the appearance of the content to be displayed, extends the battery life, and reduces the number of battery recharging times.

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to create content in an artificial reality and/or are otherwise used in an artificial reality. The artificial reality system that provides the artificial reality content may be implemented on various platforms, including a wearable device (e.g., headset) connected to a host computer system, a standalone wearable device (e.g., headset), a mobile device or computing system, or any other hardware platform capable of providing artificial reality content to one or more viewers.

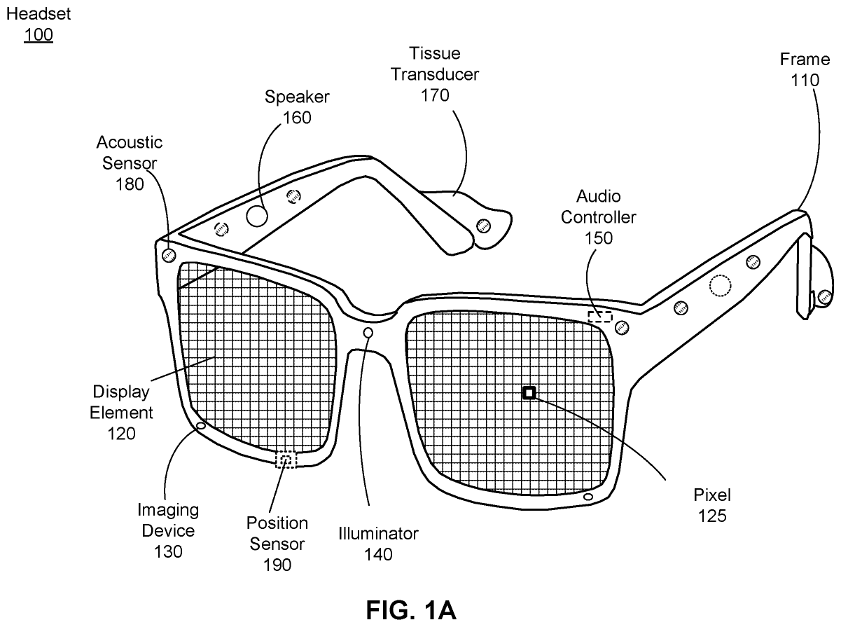

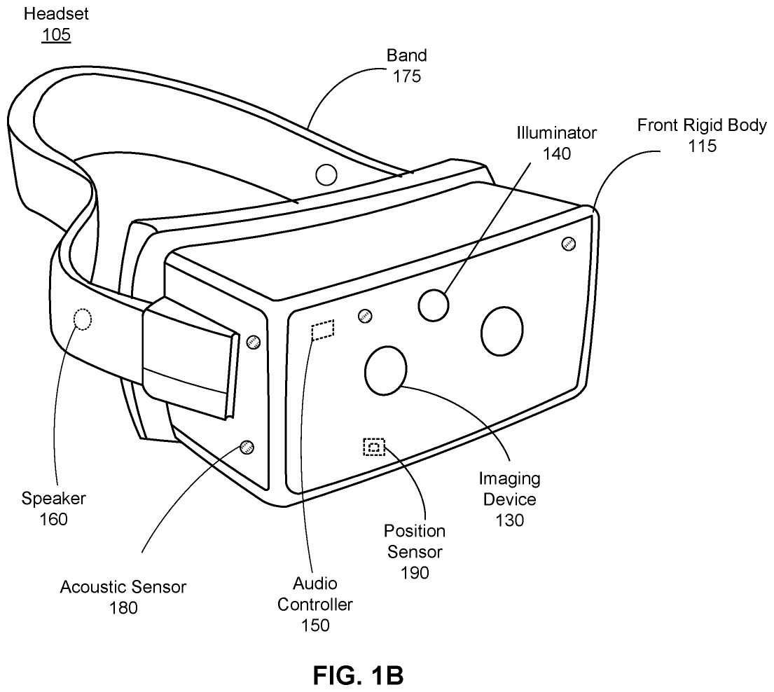

FIG. 1A is a perspective view of a headset 100 implemented as an eyewear device, in accordance with one or more embodiments. In some embodiments, the eyewear device is a near eye display (NED). In general, the headset 100 may be worn on the face of a user such that content (e.g., media content) is presented using a display assembly and/or an audio system. However, the headset 100 may also be used such that media content is presented to a user in a different manner. Examples of media content presented by the headset 100 include one or more images, video, audio, or some combination thereof. The headset 100 includes a frame and a display assembly including one or more display elements 120, and may include, among other components, a depth camera assembly (DCA), an audio system, and a position sensor 190. While FIG. 1A illustrates the components of the headset 100 in example locations on the headset 100, the components may be located elsewhere on the headset 100, on a peripheral device paired with the headset 100, or some combination thereof. Similarly, there may be more or fewer components on the headset 100 than what is shown in FIG. 1A.

The frame 110 holds the other components of the headset 100. The frame 110 includes a front part that holds the one or more display elements 120 and end pieces (e.g., temples) to attach to a head of the user. The front part of the frame 110 bridges the top of a nose of the user. The length of the end pieces may be adjustable (e.g., adjustable temple length) to fit different users. The end pieces may also include a portion that curls behind the ear of the user (e.g., temple tip, ear piece).

The one or more display elements 120 provide light to a user wearing the headset 100. As illustrated the headset includes a display element 120 for each eye of a user. In some embodiments, a display element 120 generates image light that is provided to an eyebox of the headset 100. The eyebox is a location in space that an eye of user occupies while wearing the headset 100. For example, a display element 120 may be a waveguide display. A waveguide display includes a light emitting element (e.g., a two-dimensional source, one or more line sources, one or more point sources, etc.) and one or more waveguides. Light from the light emitting element is in-coupled into the one or more waveguides which outputs the light in a manner such that there is pupil replication in an eyebox of the headset 100. In-coupling and/or outcoupling of light from the one or more waveguides may be done using one or more diffraction gratings. In some embodiments, the waveguide display includes a scanning element (e.g., waveguide, mirror, etc.) that scans light from the light emitting element as it is in-coupled into the one or more waveguides. Note that in some embodiments, one or both of the display elements 120 are opaque and do not transmit light from a local area around the headset 100. The local area is the area surrounding the headset 100. For example, the local area may be a room that a user wearing the headset 100 is inside, or the user wearing the headset 100 may be outside and the local area is an outside area. In this context, the headset 100 generates VR content. Alternatively, in some embodiments, one or both of the display elements 120 are at least partially transparent, such that light from the local area may be combined with light from the one or more display elements to produce AR and/or MR content.

The display element 120 includes an array of light emitting elements. The light emitting elements may include light emitting elements, such as, light-emitting diodes (LEDs), organic light-emitting diodes (OLEDs), or microLEDs. MicroLEDs may refer to arrays of microscopic LEDs forming individual pixel elements. In some implementations, each of the light emitting elements may correspond to a pixel of an image for display, for example, pixel 125 in FIG. 1A. Each light emitting element may be controlled to be active or inactive such that the corresponding pixel of image may be presented or not presented, i.e., visible or invisible to a user. When part or all of the light emitting elements are activated, the corresponding part or all pixels of the image are presented to the user; when all of light emitting elements are inactivated, none of the pixels of the image is presented to the user.

In some embodiments, the display element 120 may include an additional optics block (not shown). The optics block may include one or more optical elements (e.g., lens, Fresnel lens, etc.) that direct light from the display element 120 to the eyebox. The optics block may, e.g., correct for aberrations in some or all of the image content, magnify some or all of the image, or some combination thereof.

The DCA determines depth information for a portion of a local area surrounding the headset 100. The DCA includes one or more imaging devices 130 and a DCA controller (not shown in FIG. 1A), and may also include an illuminator 140. In some embodiments, the illuminator 140 illuminates a portion of the local area with light. The light may be, e.g., structured light (e.g., dot pattern, bars, etc.) in the infrared (IR), IR flash for time-of-flight, etc. In some embodiments, the one or more imaging devices 130 capture images of the portion of the local area that include the light from the illuminator 140. As illustrated, FIG. 1A shows a single illuminator 140 and two imaging devices 130. In alternate embodiments, there is no illuminator 140 and at least two imaging devices 130.

The DCA controller computes depth information for the portion of the local area using the captured images and one or more depth determination techniques. The depth determination technique may be, e.g., direct time-of-flight (ToF) depth sensing, indirect ToF depth sensing, structured light, passive stereo analysis, active stereo analysis (uses texture added to the scene by light from the illuminator 140), some other technique to determine depth of a scene, or some combination thereof.

The audio system provides audio content. The audio system includes a transducer array, a sensor array, and an audio controller 150. However, in other embodiments, the audio system may include different and/or additional components. Similarly, in some cases, functionality described with reference to the components of the audio system can be distributed among the components in a different manner than is described here. For example, some or all of the functions of the controller may be performed by a remote server.

The transducer array presents sound to user. The transducer array includes a plurality of transducers. A transducer may be a speaker 160 or a tissue transducer 170 (e.g., a bone conduction transducer or a cartilage conduction transducer). Although the speakers 160 are shown exterior to the frame 110, the speakers 160 may be enclosed in the frame 110. In some embodiments, instead of individual speakers for each ear, the headset 100 includes a speaker array comprising multiple speakers integrated into the frame 110 to improve directionality of presented audio content. The tissue transducer 170 couples to the head of the user and directly vibrates tissue (e.g., bone or cartilage) of the user to generate sound. The number and/or locations of transducers may be different from what is shown in FIG. 1A.

The sensor array detects sounds within the local area of the headset 100. The sensor array includes a plurality of acoustic sensors 180. An acoustic sensor 180 captures sounds emitted from one or more sound sources in the local area (e.g., a room). Each acoustic sensor is configured to detect sound and convert the detected sound into an electronic format (analog or digital). The acoustic sensors 180 may be acoustic wave sensors, microphones, sound transducers, or similar sensors that are suitable for detecting sounds.

In some embodiments, one or more acoustic sensors 180 may be placed in an ear canal of each ear (e.g., acting as binaural microphones). In some embodiments, the acoustic sensors 180 may be placed on an exterior surface of the headset 100, placed on an interior surface of the headset 100, separate from the headset 100 (e.g., part of some other device), or some combination thereof. The number and/or locations of acoustic sensors 180 may be different from what is shown in FIG. 1A. For example, the number of acoustic detection locations may be increased to increase the amount of audio information collected and the sensitivity and/or accuracy of the information. The acoustic detection locations may be oriented such that the microphone is able to detect sounds in a wide range of directions surrounding the user wearing the headset 100.

The audio controller 150 processes information from the sensor array that describes sounds detected by the sensor array. The audio controller 150 may comprise a processor and a computer-readable storage medium. The audio controller 150 may be configured to generate direction of arrival (DOA) estimates, generate acoustic transfer functions (e.g., array transfer functions and/or head-related transfer functions), track the location of sound sources, form beams in the direction of sound sources, classify sound sources, generate sound filters for the speakers 160, or some combination thereof.

The position sensor 190 generates one or more measurement signals in response to motion of the headset 100. The position sensor 190 may be located on a portion of the frame 110 of the headset 100. The position sensor 190 may include an inertial measurement unit (IMU). Examples of position sensor 190 include: one or more accelerometers, one or more gyroscopes, one or more magnetometers, another suitable type of sensor that detects motion, a type of sensor used for error correction of the IMU, or some combination thereof. The position sensor 190 may be located external to the IMU, internal to the IMU, or some combination thereof.

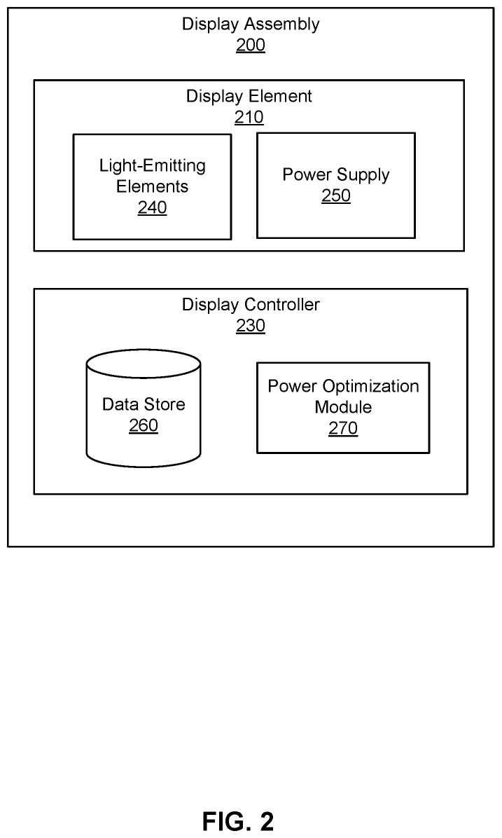

In some embodiments, the headset 100 may provide for simultaneous localization and mapping (SLAM) for a position of the headset 100 and updating of a model of the local area. For example, the headset 100 may include a passive camera assembly (PCA) that generates color image data. The PCA may include one or more RGB cameras that capture images of some or all of the local area. In some embodiments, some or all of the imaging devices 130 of the DCA may also function as the PCA. The images captured by the PCA and the depth information determined by the DCA may be used to determine parameters of the local area, generate a model of the local area, update a model of the local area, or some combination thereof. Furthermore, the position sensor 190 tracks the position (e.g., location and pose) of the headset 100 within the room. Additional details regarding the components of the headset 100 are discussed below in connection with FIG. 2.

FIG. 1B is a perspective view of a headset 105 implemented as a HMD, in accordance with one or more embodiments. In embodiments that describe an AR system and/or a MR system, portions of a front side of the HMD are at least partially transparent in the visible band (˜380 nm to 750 nm), and portions of the HMD that are between the front side of the HMD and an eye of the user are at least partially transparent (e.g., a partially transparent electronic display). The HMD includes a front rigid body 115 and a band 175. The headset 105 includes many of the same components described above with reference to FIG. 1A, but modified to integrate with the HMD form factor. For example, the HMD includes a display assembly (e.g., as described below with regard to FIG. 2), a DCA, an audio system, and a position sensor 190. FIG. 1B shows the illuminator 140, a plurality of the speakers 160, a plurality of the imaging devices 130, a plurality of acoustic sensors 180, and the position sensor 190. The speakers 160 may be located in various locations, such as coupled to the band 175 (as shown), coupled to front rigid body 115, or may be configured to be inserted within the ear canal of a user.

FIG. 2 is a block diagram of a display assembly 200, in accordance with one or more embodiments. The display assembly in FIG. 1A or FIG. 1B may be an embodiment of the display assembly 200. The display assembly 200 displays visual content. The display assembly 200 may be used in a LED-based VR/AR displays (headsets, glasses, etc.) for virtual reality and augmented reality applications. The display assembly 200 may also be used in any LED-based displays, such as TV, mobile surfaces, smartphones, etc. In the embodiment of FIG. 2, the display assembly 200 includes one or more display elements 210, and a display controller 230. The display assembly 200 performs content aware activation of the one or more display elements 210. Some embodiments of the display assembly 200 have different components than those described here. Similarly, in some cases, functions can be distributed among the components in a different manner than is described here.

The one or more display elements 210 present visual content. In some embodiments, there may be one or more display elements 210 for each eye of a user. For example, there may be a display element 210 for a one eye of the user, and another display element for the other eye of the user. In some embodiments, a display element 210 generates image light that is provided to an eyebox (e.g., of a headset). As shown, the display element 210 includes light emitting elements 240 and a power supplies 250. In other embodiments, the power supply 250 is not part of the display element 210 and/or there are a plurality of power supplies 250.

The light emitting elements 240 emit visual content in accordance with instructions from the display controller 230. The light emitting elements 240, may include any electric component that can emit light, such as, LEDs, OLEDs, microLEDs, etc. MicroLEDs may refer to arrays of microscopic LEDs forming individual pixel elements. In some embodiment, each light emitting element 240 corresponds to a pixel element and each light emitting element 240 can be controlled individually. Alternatively, a light emitting element 240 may refer to a group of microscopic light emitting elements, where each group corresponds to a pixel element and the group is controlled individually.

The power supply 250 provides power to activate the light emitting elements 240. In some embodiments, the power to activate the light emitting elements 240 is in a form of voltage. In some embodiments, each light emitting element 240 has a corresponding power supply 250. Alternatively, the light emitting elements 240 may be grouped into a certain number of groups, and the light emitting elements 240 in the same group share the same power supply 250, and each group has its own power supply 250.

The display controller 230 controls operation of the display assembly 200. In the embodiment of FIG. 2, the display controller 230 includes a data store 260, and a power optimization module 270. The display controller 230 may be located inside a headset, in some embodiments. Some embodiments of the display controller 230 have different components than those described here. Similarly, functions can be distributed among the components in different manners than described here. For example, some functions of the display controller 230 may be performed external to the display assembly 200.

The data store 260 stores data for use by the display assembly 200. Data in the data store 260 may include content to be rendered by the one or more display elements 210, heatmap model, power optimization formulations, metadata, and other data relevant for use by the display assembly 200, or any combination thereof. The heatmap model is used to generate a heatmap for an image (e.g., image frame of a video). For example, an image is associated with a plurality of pixels, and the heatmap describes an importance level of each pixel of the image. The generated heatmap may describe the importance level of the pixels based in part on the characteristics of the input image, such as saliency, edges, semantic, foreground/background, intensity overall or per color channel, color, texture, depth, some other characteristic of the input image, or some combination thereof.

The power optimization formulations incorporate the heatmap, one or more cost functions, and one or more power constraints to reduce the power consumption of the light emitting elements 240 while preserving the “appearance” of the content of the image to be displayed. In one example, a cost function may be used to minimize the sum of costs of the activated the light emitting elements 240, by limiting the total number of the light emitting elements 240 to be activated. In another example, the power optimization functions may modify the individual cost with soft constraints. A soft constrain may be achieved by adding a term associated with the cost to achieve spatial/temporal smoothness. For instance, the power constraint comprises a spatial factor that coordinates the activation of the light emitting elements 240 spatially with spatial neighboring cost factors. The power constraint may comprise a temporal factor that coordinates the activation of the light emitting elements 240 with a temporal continuity factor to avoid a flicking effect.

In some embodiments, for playback/offline experience (e.g., play a video content), the display assembly 200 may pre-optimize the light emitting elements 240 activation and add to the image as metadata, so that the display assembly 200 can directly use this metadata to control the activation of the light emitting elements 240 without additional computation.

The power optimization module 270 is configured to access the data store 260 to compute a heatmap for an image and determine a power optimization function to control the light emitting elements 240 for display the image. The power optimization module 270 determines for each light emitting element 240 whether it will be active or inactive using the power optimization functions, which includes the heatmap, one or more cost functions, and at least one power constraint. In some embodiments, based in part on the heatmap, the power optimization module 270 may activate a portion of the light emitting elements that correspond to a portion of pixels of the image having a higher importance level; and deactivate the other portion of the light emitting elements that correspond to the other portion of pixels of the image having a lower importance level. In some embodiments, the power optimization module 270 may use the power functions to set cost limitations and constraints to reduce the power consumption of the light emitting elements 240 while preserving the “appearance” of the content of the image to be displayed.

In some implementations, the display assembly may associate the visual content with a “cost” of the pixels of the image. The “cost” may include spatial or temporal smoothness of the visual effect of the visual content that is presented by the activated display elements. In some implementations, the display assembly may determine which light emitting elements to be activated based in part on power constrains of the light emitting elements. The power contains may include any retrains on the power consumption of the display elements, for example, the total amount of power consumed by the light emitting elements, the total number of activated light emitting elements. In some embodiments, the display assembly may control the display elements based on the heatmap, one or more cost functions, and/or one or more power constraints to generate visual content. For example, the display assembly uses the heatmap in a mathematical optimization framework to automatically select which light emitting elements to activate or not activate, with respect to some constrains or costs.

In some embodiments, the display assembly 200 may determine the light emitting elements to be activated in a way that the sum of costs of the activated light emitting elements is minimized. For example, the display assembly 200 may limit that the number of activated light emitting elements to be K. In another example, the display assembly 200 may use a formulation to optimize the activated light emitting elements. In one example, assuming the total number of light emitting elements is N, K is the maximum number of activated light emitting elements. Each light emitting element has a cost (cᵢ) assigned based in part on its power consumption and visual effect, i.e., a cost of the display area of the i-th light emitting element. Each cost (cᵢ) may be computed based on the heatmap, the level of degrading the original information in the texture of the image, the level of degrading the aesthetic quality, etc. In some implementations, assuming the display assembly 200 is a binary activation system, i.e., a light emitting element is either activated or not activated, yᵢ is an unknown binary variable indicating whether the i-th light emitting element is on or off. When yᵢ=0, the i-th light emitting element is off, and when yᵢ=1, the i-th light emitting element is on. The vector y is the concatenation of the binary variables yᵢ, i.e., y={y₁, . . . , yᵢ, . . . , y_{N}}. The formulations to reduce the total cost of the N light emitting elements with a given power budget (e.g., maximum number of activated light emitting elements=K) can be presented in the following manner:

$${min}_{y} {\sum }_{i}^{N} {y}_{i} {c}_{i} , \qquad ( 1 )$$

$$s . t . {\sum }_{i}^{N} {y}_{i} = K , \qquad ( 2 )$$

$${y}_{i} ∈ \{ 0 , 1 \} , {∀}_{i} = 1 , ... , N . \qquad ( 3 )$$

Here, the formulation uses binary variables with linear cost and linear constraints, which is a binary linear programming system, and thus can be solved optimally by a Binary Linear Programming. Alternatively, the display assembly 200 may select the top-K costs, i.e., the K light emitting elements with the smallest costs by determining the indices of the K smallest costs. For example, the display assembly 200 may determine the smallest costs by sorting an array of the indices of the K, or use other methods known in the field.

In some embodiments, the display assembly 200 may modify the individual cost with soft constraints. A soft constrain may be achieved by adding a term associated with the cost to achieve spatial/temporal smoothness. The use of soft constraints is a tradeoff analysis between metrics (e.g., content preservation vs. power usage and number of activated light emitting elements).

In one example, the display assembly 200 may reduce the total costs of the light emitting elements using an “inverse” of the heatmap cost, i.e., (1-cᵢ). Assuming the power consumption of a single light emitting element is a scalar, p, the formulations to reduce the total cost of the N light emitting elements can be presented in the following manner:

$${max}_{y} {ω}_{c} {\sum }_{i}^{N} {y}_{i} ( 1 - {c}_{i} ) - {ω}_{p} {\sum }_{i}^{N} {y}_{i} {p}_{i} \qquad ( 4 )$$

$$s . t . {y}_{i} ∈ \{ 0 , 1 \} , {∀}_{i} = 1 , ... , N \qquad ( 5 )$$

Here, the first term of formulation (4) represents the contribution to the overall cost, and the second term of formulation (4) represents the overall power consumption, ω_{c} and ωₚ are relative weights to balance the importance of the two terms. In some embodiments, all light emitting elements may have the same power consumption p; alternatively, the power consumption p may vary depending on the individual light emitting element.

In formulation (1), the activation of a light emitting element is independent of its neighbors, which might lead to “unstructured” or non-smooth activations. For example, on a row of an image, the neighboring pixels may be on-off-on-off-on-off, showing a “zig-zag” lightening boundary. In some embodiments, the display assembly 200 may modify the formulations by adding spatial neighboring cost factors, and the formulation can be presented in the following manner:

$${Min}_{y} {ω}_{c} {\sum }_{i}^{N} {y}_{i} {c}_{i} + {ω}_{s} {\sum }_{i}^{N} {\sum }_{j ∈ N ( i )} {S}_{spatial} ( {y}_{i} , {y}_{j} ) \qquad ( 6 )$$

$$s . t . {{\sum }^{N}}_{i} {y}_{i} = K , \qquad ( 2 )$$

$${y}_{i} ∈ \{ 0 , 1 \} , {∀}_{i} = 1 , ... , N . \qquad ( 3 )$$

Here, s(u,v)=0, if u=v; and s(u,v)=1, otherwise. N(i) represents the spatial light emitting element neighbors of the i-th light emitting element, and ω_{c} and ωₛ are relative weights to balance the importance of the first and second terms of the formulation (6), i.e., cost and spatial smoothness. In this way, the spatial smoothness cost Sₛₚₐₜᵢₐₗ(yᵢ,) may cause the spatial neighboring light emitting elements to be in the same activation status (activate or inactivate).

In some embodiments, the display assembly 200 may modify the formulations with a temporal continuity component to avoid a flicking effect. In this way, the light emitting elements may have the same activation status along time so that the displayed visual content does not show a “blinking Christmas tree” effect. The formulation can be presented in the following manner:

$${min}_{{y}^{t}} {ω}_{c} {\sum }_{i}^{N} {y}_{i}^{t} {c}_{i} + {ω}_{s} {\sum }_{i}^{N} {\sum }_{{t}^{′} = t - W}^{t - 1} {S}_{temp} ( {y}_{i}^{{t}^{′}} , {y}_{i}^{{t}^{′} + 1} ) \qquad ( 7 )$$

$$s . t . {\sum }_{i}^{N} {y}_{i}^{t} = K \qquad ( 8 )$$

$${y}_{i} ∈ \{ 0 , 1 \} , {∀}_{i} = 1 , ... , N \qquad ( 9 )$$

Here, ω_{c} and ware relative weights to balance the importance of the first and second term of the formulation (7), i.e., cost and temporal smoothness, and W is the length of the temporal window. In this way, the display assembly 200 applies a soft constraint on the light emitting elements by balancing the cost with a weight and setting a temporal window. Otherwise, it would be a hard constraint where certain light emitting elements will always have the same status, i.e., staying on or off. In another implementation, the display assembly 200 may compute every image or frame by frame to filter the heatmap temporally. In this way, the current heatmap is filtered temporally with the previous heatmaps so that the heatmap is temporally smoother in turn, and the activation of the light emitting elements is also temporally smoother in turn.

The cost and constraints can be adjusted to different use cases and requirements. For example, the spatial smoothness and temporal smoothness constrains may be used in certain implementations and not used in others. Similarly, the weights of the different terms of the cost function may be adjusted based on user requirements.

In some embodiments, the visual content to be displayed may be sent from a sender (e.g., server, remote participant in a call) to a receiver (e.g., the device of the user), the process of using the heatmap to control the display elements 210 may be partially or all performed on the sender side, receiver side, or even in the cloud. In some embodiments, for playback/offline experience (e.g., play a video content), the display assembly 200 may pre-optimize the light emitting elements 240 activation and add to the image as metadata, so that the display assembly 200 can directly use this metadata to control the activation of display elements 210 without additional computation.

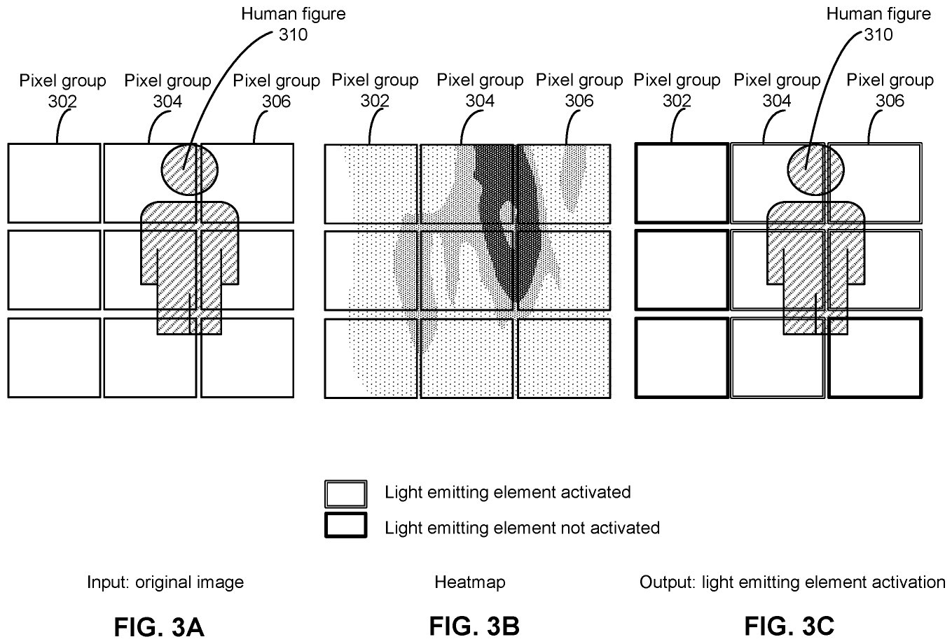

FIGS. 3A-3C illustrate an exemplary process of using a heatmap for controlling a display element to present visual content, in accordance with one or more embodiments. The process shown in FIGS. 3A-3C may be performed by components of a display assembly (e.g., display assembly 200). Other entities may perform some or all of the steps in FIGS. 3A-3C in other embodiments. Embodiments may include different and/or additional steps, or perform the steps in different orders. FIGS. 3A-3C use an image containing visual content for display as an example. In some embodiments the visual content may be associated with an image, video, AR avatar, etc. In some embodiments, the visual content may be in a form of picture, diagram, chart, infographic, online video, screenshot, meme, slide deck, etc.

FIG. 3A illustrates an exemplary display assembly for presenting visual content of an image, in accordance with one or more embodiments. As shown in FIG. 3A, the display assembly (e.g., the display assembly 200) receives a signal corresponding to an image as an input and is configured to generate visual content corresponding to the image. The image may be associated with a plurality of pixels, and in some embodiments, the pixels may be grouped into one or more groups. For example, in FIG. 3A, the pixels are grouped into 9 pixel groups, e.g., pixel group 302, pixel group 304, pixel group 306, etc. The display assembly controls the light emitting elements corresponding to the pixel groups to present the visual content. The number of pixel groups in FIG. 3A is for illustration; it is not intended to be exhaustive or to limit the patent rights to the precise forms disclosed. Persons skilled in the relevant art can appreciate that different number of pixel groups or individual pixels may be used for the configuration of the display assembly.

The display assembly may control the light emitting elements at the individual level or at a group level, depending on certain system constraints or requirements (e.g., execution speed, quality, etc.). In some embodiments, each light emitting element corresponds to a pixel and each light emitting element can be controlled individually and each pixel is presented independently. In some embodiments, the light emitting elements may be grouped into one or more groups, where each group corresponds to a pixel of the image. The group is controlled individually, all the light emitting elements in a same group are controlled collectively by the display assembly 200, i.e., having the same activation status. Alternatively, as shown in FIG. 3A, the pixels of the image may be grouped and presented by a light emitting element. The pixels in the same pixel groups are presented collectively. In FIG. 3A, the display assembly uses a plurality of microLEDs as the light emitting elements 240, and each microLED corresponds to a pixel group associated with the image.

An image may include different portions of pixels that have different levels of importance. For example, FIG. 3A shows an image includes a human FIG. 310 as a primary content, and the pixel groups corresponding to the human FIG. 310 may be considered as most important to a user. The image may also include other background visual content, and the corresponding pixel groups may be considered as less important to the user.

FIG. 3B illustrates a heatmap corresponding to the image generated by the display assembly, in accordance with one or more embodiments. In FIG. 3B, the display assembly (e.g., the display assembly 200) generates a heatmap corresponding to the input image, which describes an importance level of each pixel group of the image. As shown in FIG. 3B, pixel groups with higher intensities (illustrated with darker/denser points) are associated with pixel groups of visual content having higher importance level; and pixel groups with lower intensities (illustrated with lighter/more scattered points) are associated with pixels of visual content with lower importance level. Here, the pixel groups that correspond to the human FIG. 310 have higher intensities in the heatmap in FIG. 3B.

The display assembly may determine the importance level of the pixels based in part on the characteristics of the input image, such as saliency, edges, semantic, foreground/background, intensity overall or per color channel, color, texture, depth, some other characteristics of the input image, or some combination thereof. In some embodiments, the display assembly generates a heatmap based in part on some or all of the characteristics of the input image, for example, by combining some of the characteristics in a linear or non-linear manner. In some implementations, the display assembly calculates the heatmap with in-process steps; alternatively, the display assembly calculate the heatmap with post-processing steps (e.g., depth).

In some embodiments, the display assembly uses the generated heatmap to determine which pixels to be presented to the user. For example, based on the generated heatmap in FIG. 3B, the display assembly determines that the pixel groups with higher importance levels, i.e., pixel groups associated with the human FIG. 310, should be displayed. In some embodiments, each light emitting element corresponds to the display of a pixel of the image; alternatively, one or more light emitting elements may be grouped in one group, and each group of light emitting elements corresponds to a pixel (group) of the image.

FIG. 3C illustrates an activation of the light emitting elements based on the generated heatmap for presenting the image, in accordance with one or more embodiments. In FIG. 3C, the display assembly activates the corresponding light emitting elements corresponding to the more important pixel groups, e.g., pixel group 304 and pixel group 306, etc. The other microLEDs corresponding to the less important pixels, e.g., pixel group 302, are not activated. In this way, the display assembly selects and controls the light emitting elements to present the visual content. The inactivated light emitting elements do not consume power. Thus, while preserving the “appearance” of the visual content to be displayed, the display assembly reduces the total number of activated light emitting elements and reduces the power consumption. As illustrated as a plurality of squares in FIGS. 3A-3C, each light emitting element may be controlled to be active or inactive such that the corresponding pixel group of image may be presented or not presented, i.e., visible or invisible to a user. When part or all of the light emitting elements are activated, the corresponding part or all of the pixel groups of the image are presented to the user; when all of light emitting elements are inactivated, none of the pixel groups is presented to the user.

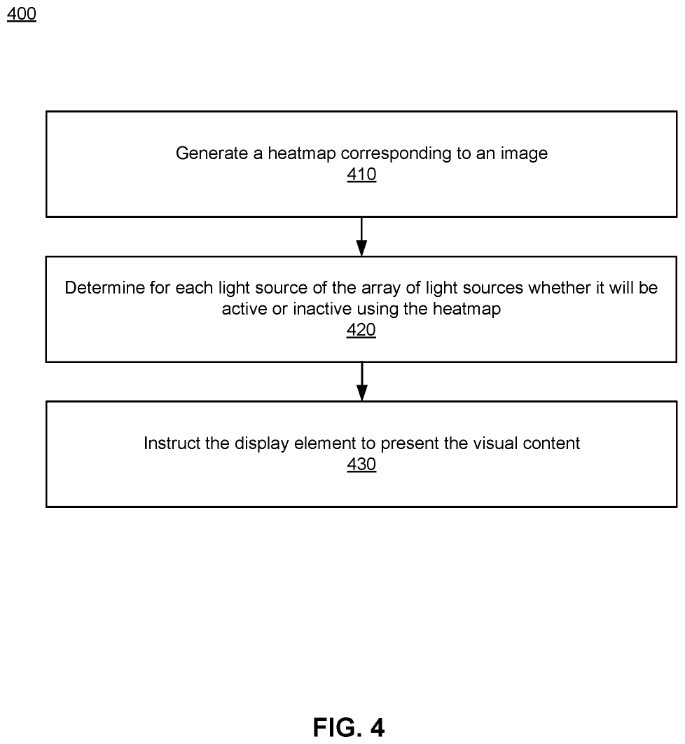

FIG. 4 is a flowchart of a method 400 of controlling a display element for presenting visual content, in accordance with one or more embodiments. The process shown in FIG. 4 may be performed by components of a display assembly (e.g., display assembly 200). Other entities may perform some or all of the steps in FIG. 4 in other embodiments. Embodiments may include different and/or additional steps, or perform the steps in different orders.

As shown in FIG. 4, the display assembly 200 generates 410 a heatmap corresponding to an image. The image is associated with a plurality of pixels that each corresponds to a different light emitting element of the array of light emitting elements. In some embodiments, the light emitting elements include, LEDs, OLEDs, or microLEDs, etc. The image may be associated with a plurality of pixels, and the heatmap describes an importance level of each pixel of the image. The display assembly 200 may determine the importance level of the pixels based in part on the characteristics of the input image, such as saliency, edges, semantic, foreground/background, intensity overall or per color channel, color, texture, depth, some other characteristic of the input image, or some combination thereof.

The display assembly 200 determines 420 for each light emitting element of the array of light emitting elements whether it will be active or inactive using the heatmap, one or more cost functions, and at least one power constraint to generate visual content.

In some embodiments, the display assembly 200 activates a portion of the light emitting elements that correspond to a portion of pixels of the image having a higher importance level; and deactivate the other portion of the light emitting elements that correspond to the other portion of pixels of the image having a lower importance level.

In some embodiments, the display assembly 200 determines the light emitting elements to be activated in a way that the sum of costs of the activated light emitting elements is minimized. For example, the display assembly 200 may limit the total number of light emitting elements to be activated.

In some embodiments, the display assembly 200 modifies the individual cost with soft constraints, i.e., a term associated with the cost to achieve spatial/temporal smoothness. In one example, the power constraint comprises a spatial factor that coordinates the activation of the light emitting elements spatially. The display assembly 200 may modify the activation of the light emitting elements with spatial neighboring cost factors. In another example, the power constraint comprises a temporal factor that coordinates the activation of the light emitting elements in time. The display assembly 200 may control the activation of the light emitting elements with a temporal continuity factor to avoid a flicking effect of the light emitting elements.

The display assembly 200 instructs 430 the display element to present the visual content. For example, the display assembly 200 may instruct a power supply to generate one or more supply voltages to activate light emitting elements that are determined to be activated. In some embodiments, the display assembly 200 may control each light emitting element individually; and alternatively, the light emitting elements may be grouped into a certain number of groups, all the light emitting elements in a same group may be controlled collectively by the display assembly 200, i.e., having the same activation status.

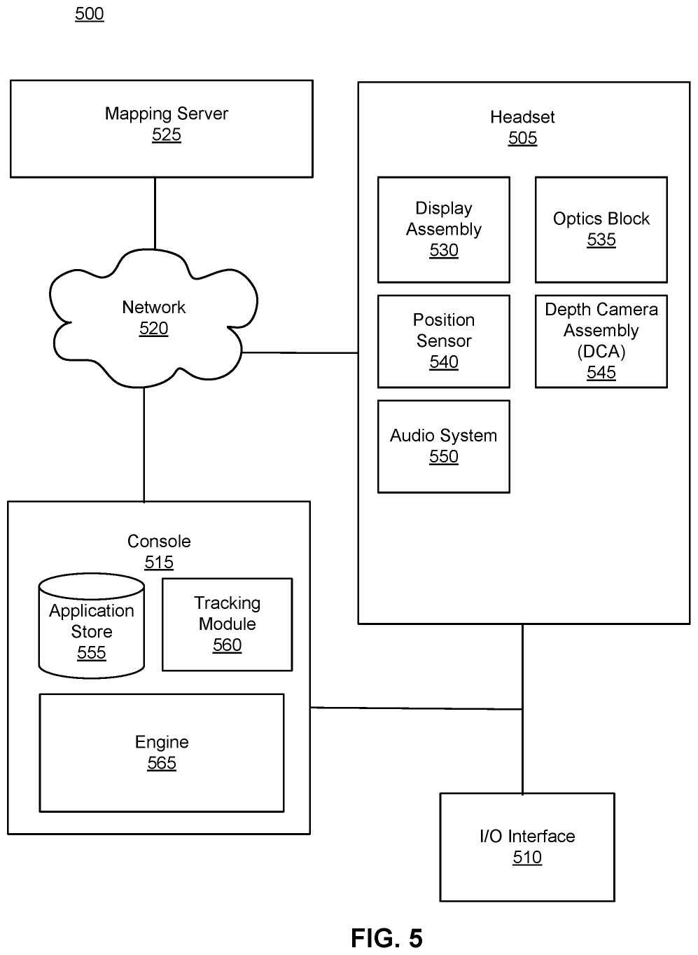

FIG. 5 is a system 500 that includes a headset 505, in accordance with one or more embodiments. In some embodiments, the headset 505 may be the headset 100 of FIG. 1A or the headset 105 of FIG. 1B. The system 500 may operate in an artificial reality environment (e.g., a virtual reality environment, an augmented reality environment, a mixed reality environment, or some combination thereof). The system 500 shown by FIG. 5 includes the headset 505, an input/output (I/O) interface 510 that is coupled to a console 515, and the network 520, and the mapping server 525. While FIG. 5 shows an example system 500 including one headset 505 and one I/O interface 510, in other embodiments any number of these components may be included in the system 500. For example, there may be multiple headsets each having an associated I/O interface 510, with each headset and I/O interface 510 communicating with the console 515. In alternative configurations, different and/or additional components may be included in the system 500. Additionally, functionality described in conjunction with one or more of the components shown in FIG. 5 may be distributed among the components in a different manner than described in conjunction with FIG. 5 in some embodiments. For example, some or all of the functionality of the console 515 may be provided by the headset 505.

The headset 505 includes the display assembly 530, an optics block 535, one or more position sensors 540, and the DCA 545. Some embodiments of headset 505 have different components than those described in conjunction with FIG. 5. Additionally, the functionality provided by various components described in conjunction with FIG. 5 may be differently distributed among the components of the headset 505 in other embodiments, or be captured in separate assemblies remote from the headset 505.

The display assembly 530 displays content to the user in accordance with data received from the console 515. The display assembly 530 displays the content using one or more display elements (e.g., the display elements 120). A display element may be, e.g., an electronic display. The display element includes an array of light emitting elements. In various embodiments, the display assembly 530 comprises a single display element or multiple display elements (e.g., a display for each eye of a user). Examples of an electronic display include: a liquid crystal display (LCD), an organic light emitting diode (OLED) display, microLED, an active-matrix organic light-emitting diode display (AMOLED), waveguide display, some other display, or some combination thereof. In some embodiments, each light emitting element has a corresponding power supply. Alternatively, the light emitting elements may be grouped into a certain number of groups, and the light emitting elements in the same group share the same power supply, and each group has its own power supply. The display assembly 530 includes a display controller that controls operation of the display assembly 530. The display controller includes a data store and a power optimization module. The data store stores data for use by the display assembly 530. Data in the data store may include content to be rendered by the one or more display element, heatmap model, power optimization formulations, metadata, and other data relevant for use by the display assembly 530, or any combination thereof. The power optimization module accesses the data store to compute a heatmap for an image and determine a power optimization function to control the light emitting elements for display the image. Note in some embodiments, the display element 120 may also include some or all of the functionality of the optics block 535.

The optics block 535 may magnify image light received from the electronic display, corrects optical errors associated with the image light, and presents the corrected image light to one or both eyeboxes of the headset 505. In various embodiments, the optics block 535 includes one or more optical elements. Example optical elements included in the optics block 535 include: an aperture, a Fresnel lens, a convex lens, a concave lens, a filter, a reflecting surface, or any other suitable optical element that affects image light. Moreover, the optics block 535 may include combinations of different optical elements. In some embodiments, one or more of the optical elements in the optics block 535 may have one or more coatings, such as partially reflective or anti-reflective coatings.

Magnification and focusing of the image light by the optics block 535 allows the electronic display to be physically smaller, weigh less, and consume less power than larger displays. Additionally, magnification may increase the field of view of the content presented by the electronic display. For example, the field of view of the displayed content is such that the displayed content is presented using almost all (e.g., approximately 110 degrees diagonal), and in some cases, all of the user's field of view. Additionally, in some embodiments, the amount of magnification may be adjusted by adding or removing optical elements.

In some embodiments, the optics block 535 may be designed to correct one or more types of optical error. Examples of optical error include barrel or pincushion distortion, longitudinal chromatic aberrations, or transverse chromatic aberrations. Other types of optical errors may further include spherical aberrations, chromatic aberrations, or errors due to the lens field curvature, astigmatisms, or any other type of optical error. In some embodiments, content provided to the electronic display for display is pre-distorted, and the optics block 535 corrects the distortion when it receives image light from the electronic display generated based on the content.

The position sensor 540 is an electronic device that generates data indicating a position of the headset 505. The position sensor 540 generates one or more measurement signals in response to motion of the headset 505. The position sensor 190 is an embodiment of the position sensor 540. Examples of a position sensor 540 include: one or more IMUs, one or more accelerometers, one or more gyroscopes, one or more magnetometers, another suitable type of sensor that detects motion, or some combination thereof. The position sensor 540 may include multiple accelerometers to measure translational motion (forward/back, up/down, left/right) and multiple gyroscopes to measure rotational motion (e.g., pitch, yaw, roll). In some embodiments, an IMU rapidly samples the measurement signals and calculates the estimated position of the headset 505 from the sampled data. For example, the IMU integrates the measurement signals received from the accelerometers over time to estimate a velocity vector and integrates the velocity vector over time to determine an estimated position of a reference point on the headset 505. The reference point is a point that may be used to describe the position of the headset 505. While the reference point may generally be defined as a point in space, however, in practice the reference point is defined as a point within the headset 505.

The DCA 545 generates depth information for a portion of the local area. The DCA includes one or more imaging devices and a DCA controller. The DCA 545 may also include an illuminator. Operation and structure of the DCA 545 is described above with regard to FIG. 1A.

The audio system 550 provides audio content to a user of the headset 505. The audio system 550 is substantially the same as the audio system describe above. The audio system 550 may comprise one or acoustic sensors, one or more transducers, and an audio controller. The audio system 550 may provide spatialized audio content to the user. In some embodiments, the audio system 550 may request acoustic parameters from the mapping server 525 over the network 520. The acoustic parameters describe one or more acoustic properties (e.g., room impulse response, a reverberation time, a reverberation level, etc.) of the local area. The audio system 550 may provide information describing at least a portion of the local area from e.g., the DCA 545 and/or location information for the headset 505 from the position sensor 540. The audio system 550 may generate one or more sound filters using one or more of the acoustic parameters received from the mapping server 525, and use the sound filters to provide audio content to the user.

The I/O interface 510 is a device that allows a user to send action requests and receive responses from the console 515. An action request is a request to perform a particular action. For example, an action request may be an instruction to start or end capture of image or video data, or an instruction to perform a particular action within an application. The I/O interface 510 may include one or more input devices. Example input devices include: a keyboard, a mouse, a game controller, or any other suitable device for receiving action requests and communicating the action requests to the console 515. An action request received by the I/O interface 510 is communicated to the console 515, which performs an action corresponding to the action request. In some embodiments, the I/O interface 510 includes an IMU that captures calibration data indicating an estimated position of the I/O interface 510 relative to an initial position of the I/O interface 510. In some embodiments, the I/O interface 510 may provide haptic feedback to the user in accordance with instructions received from the console 515. For example, haptic feedback is provided when an action request is received, or the console 515 communicates instructions to the I/O interface 510 causing the I/O interface 510 to generate haptic feedback when the console 515 performs an action.

The console 515 provides content to the headset 505 for processing in accordance with information received from one or more of: the DCA 545, the headset 505, and the I/O interface 510. In the example shown in FIG. 5, the console 515 includes an application store 555, a tracking module 560, and an engine 565. Some embodiments of the console 515 have different modules or components than those described in conjunction with FIG. 5. Similarly, the functions further described below may be distributed among components of the console 515 in a different manner than described in conjunction with FIG. 5. In some embodiments, the functionality discussed herein with respect to the console 515 may be implemented in the headset 505, or a remote system.

The application store 555 stores one or more applications for execution by the console 515. An application is a group of instructions, that when executed by a processor, generates content for presentation to the user. Content generated by an application may be in response to inputs received from the user via movement of the headset 505 or the I/O interface 510. Examples of applications include: gaming applications, conferencing applications, video playback applications, or other suitable applications.

The tracking module 560 tracks movements of the headset 505 or of the I/O interface 510 using information from the DCA 545, the one or more position sensors 540, or some combination thereof. For example, the tracking module 560 determines a position of a reference point of the headset 505 in a mapping of a local area based on information from the headset 505. The tracking module 560 may also determine positions of an object or virtual object. Additionally, in some embodiments, the tracking module 560 may use portions of data indicating a position of the headset 505 from the position sensor 540 as well as representations of the local area from the DCA 545 to predict a future location of the headset 505. The tracking module 560 provides the estimated or predicted future position of the headset 505 or the I/O interface 510 to the engine 565.

The engine 565 executes applications and receives position information, acceleration information, velocity information, predicted future positions, or some combination thereof, of the headset 505 from the tracking module 560. Based on the received information, the engine 565 determines content to provide to the headset 505 for presentation to the user. For example, if the received information indicates that the user has looked to the left, the engine 565 generates content for the headset 505 that mirrors the user's movement in a virtual local area or in a local area augmenting the local area with additional content. Additionally, the engine 565 performs an action within an application executing on the console 515 in response to an action request received from the I/O interface 510 and provides feedback to the user that the action was performed. The provided feedback may be visual or audible feedback via the headset 505 or haptic feedback via the I/O interface 510.

The network 520 couples the headset 505 and/or the console 515 to the mapping server 525. The network 520 may include any combination of local area and/or wide area networks using both wireless and/or wired communication systems. For example, the network 520 may include the Internet, as well as mobile telephone networks. In one embodiment, the network 520 uses standard communications technologies and/or protocols. Hence, the network 520 may include links using technologies such as Ethernet, 802.11, worldwide interoperability for microwave access (WiMAX), 2G/3G/4G mobile communications protocols, digital subscriber line (DSL), asynchronous transfer mode (ATM), InfiniBand, PCI Express Advanced Switching, etc. Similarly, the networking protocols used on the network 520 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 520 can be represented using technologies and/or formats including image data in binary form (e.g., Portable Network Graphics (PNG)), hypertext markup language (HTML), extensible markup language (XML), etc. In addition, all or some of links can be encrypted using conventional encryption technologies such as secure sockets layer (SSL), transport layer security (TLS), virtual private networks (VPNs), Internet Protocol security (IPsec), etc.

The mapping server 525 may include a database that stores a virtual model describing a plurality of spaces, wherein one location in the virtual model corresponds to a current configuration of a local area of the headset 505. The mapping server 525 receives, from the headset 505 via the network 520, information describing at least a portion of the local area and/or location information for the local area. The user may adjust privacy settings to allow or prevent the headset 505 from transmitting information to the mapping server 525. The mapping server 525 determines, based on the received information and/or location information, a location in the virtual model that is associated with the local area of the headset 505. The mapping server 525 determines (e.g., retrieves) one or more acoustic parameters associated with the local area, based in part on the determined location in the virtual model and any acoustic parameters associated with the determined location. The mapping server 525 may transmit the location of the local area and any values of acoustic parameters associated with the local area to the headset 505.

One or more components of system 500 may contain a privacy module that stores one or more privacy settings for user data elements. The user data elements describe the user or the headset 505. For example, the user data elements may describe a physical characteristic of the user, an action performed by the user, a location of the user of the headset 505, a location of the headset 505, an HRTF for the user, etc. Privacy settings (or “access settings”) for a user data element may be stored in any suitable manner, such as, for example, in association with the user data element, in an index on an authorization server, in another suitable manner, or any suitable combination thereof.

A privacy setting for a user data element specifies how the user data element (or particular information associated with the user data element) can be accessed, stored, or otherwise used (e.g., viewed, shared, modified, copied, executed, surfaced, or identified). In some embodiments, the privacy settings for a user data element may specify a “blocked list” of entities that may not access certain information associated with the user data element. The privacy settings associated with the user data element may specify any suitable granularity of permitted access or denial of access. For example, some entities may have permission to see that a specific user data element exists, some entities may have permission to view the content of the specific user data element, and some entities may have permission to modify the specific user data element. The privacy settings may allow the user to allow other entities to access or store user data elements for a finite period of time.

The privacy settings may allow a user to specify one or more geographic locations from which user data elements can be accessed. Access or denial of access to the user data elements may depend on the geographic location of an entity who is attempting to access the user data elements. For example, the user may allow access to a user data element and specify that the user data element is accessible to an entity only while the user is in a particular location. If the user leaves the particular location, the user data element may no longer be accessible to the entity. As another example, the user may specify that a user data element is accessible only to entities within a threshold distance from the user, such as another user of a headset within the same local area as the user. If the user subsequently changes location, the entity with access to the user data element may lose access, while a new group of entities may gain access as they come within the threshold distance of the user.

The system 500 may include one or more authorization/privacy servers for enforcing privacy settings. A request from an entity for a particular user data element may identify the entity associated with the request and the user data element may be sent only to the entity if the authorization server determines that the entity is authorized to access the user data element based on the privacy settings associated with the user data element. If the requesting entity is not authorized to access the user data element, the authorization server may prevent the requested user data element from being retrieved or may prevent the requested user data element from being sent to the entity. Although this disclosure describes enforcing privacy settings in a particular manner, this disclosure contemplates enforcing privacy settings in any suitable manner.

### Additional Configuration Information

The foregoing description of the embodiments has been presented for illustration; it is not intended to be exhaustive or to limit the patent rights to the precise forms disclosed. Persons skilled in the relevant art can appreciate that many modifications and variations are possible considering the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
generating a heatmap corresponding to an image, and the image is associated with a plurality of pixels that each corresponds to a different light emitting element of an array of light emitting elements of a display element, and the heatmap describes an importance level of each pixel of the image;
determining for each light emitting element of the array of light emitting elements whether it will be active or inactive using the heatmap, one or more cost functions, and at least one power constraint to generate visual content; and
instructing the display element to present the visual content.

2. The method of claim 1, wherein the heatmap is generated based on one or more of saliency, edges, semantic, intensity, foreground, background, color, texture, and depth of the visual content.

3. The method of claim 1, wherein the visual content is in a form of picture, diagram, chart, infographic, online video, screenshot, meme, or slide deck.

4. The method of claim 1, wherein determining for each light emitting element of the array of light emitting elements whether it will be active or inactive using the heatmap, one or more cost functions, and at least one power constraint to generate visual content comprises:
activating one portion of the light emitting elements that correspond to one portion of pixels of the image having a higher importance level; and
deactivating the other portion of the light emitting elements that correspond to the other portion of pixels of the image having a lower importance level.

5. The method of claim 1, wherein determining for each light emitting element of the array of light emitting elements whether it will be active or inactive using the heatmap, one or more cost functions, and at least one power constraint to generate visual content comprises: determining a total number of light emitting elements to be activated.

6. The method of claim 1, wherein the at least one power constraint comprises a spatial factor that coordinates the activation of the light emitting elements spatially.

7. The method of claim 1, wherein the at least one power constraint comprises a temporal factor that coordinates the activation of the light emitting elements in time.

8. The method of claim 1, wherein instructing the display element to present the visual content comprises:
generating, by a power supply, one or more supply voltages to activate light emitting elements that are determined to be activated.

9. A non-transitory computer-readable storage medium comprising stored instructions, the instructions when executed by a processor of a device, causing the device to:
generate a heatmap corresponding to an image, and the image is associated with a plurality of pixels that each corresponds to a different light emitting element of an array of light emitting elements of a display element, and the heatmap describes an importance level of each pixel of the image;
determine for each light emitting element of the array of light emitting elements whether it will be active or inactive using the heatmap, one or more cost functions, and at least one power constraint to generate visual content; and
instruct the display element to present the visual content.

10. The non-transitory computer-readable storage medium of claim 9, wherein the heatmap is generated based on one or more of saliency, edges, semantic, intensity, foreground, background, color, texture, and depth of the visual content.

11. The non-transitory computer-readable storage medium of claim 9, wherein the visual content is in a form of picture, diagram, chart, infographic, online video, screenshot, meme, or slide deck.

12. The non-transitory computer-readable storage medium of claim 9, wherein the instruction to determine for each light emitting element of the array of light emitting elements whether it will be active or inactive using the heatmap, one or more cost functions, and at least one power constraint to generate visual content comprises:
activating one portion of the light emitting elements that correspond to one portion of pixels of the image having a higher importance level; and
deactivating the other portion of the light emitting elements that correspond to the other portion of pixels of the image having a lower importance level.

13. The non-transitory computer-readable storage medium of claim 9, wherein the instruction to determine for each light emitting element of the array of light emitting elements whether it will be active or inactive using the heatmap, one or more cost functions, and at least one power constraint to generate visual content comprises: determining a total number of light emitting elements to be activated.

14. The non-transitory computer-readable storage medium of claim 9, wherein the at least one power constraint comprises a spatial factor that coordinates the activation of the light emitting elements spatially.

15. The non-transitory computer-readable storage medium of claim 9, wherein the at least one power constraint comprises a temporal factor that coordinates the activation of the light emitting elements in time.

16. The non-transitory computer-readable storage medium of claim 9, wherein the instruction to instruct the display element to present the visual content comprises:
generating, by a power supply, one or more supply voltages to activate light emitting elements that are determined to be activated.

17. A system comprising:
a display element comprising an array of light emitting elements; and
a display controller configured to:
generate a heatmap corresponding to an image, and the image is associated with a plurality of pixels that each corresponds to a different light emitting element of the array of light emitting elements, and the heatmap describes an importance level of each pixel of the image;
determine for each light emitting element of the array of light emitting elements whether it will be active or inactive using the heatmap, one or more cost functions, and at least one power constraint to generate visual content; and
instruct the display element to present the visual content.

18. The system of claim 17, wherein determining for each light emitting element of the array of light emitting elements whether it will be active or inactive using the heatmap, one or more cost functions, and at least one power constraint to generate visual content comprises:
activating one portion of the light emitting elements that correspond to one portion of pixels of the image having a higher importance level; and
deactivating the other portion of the light emitting elements that correspond to the other portion of pixels of the image having a lower importance level.

19. The system of claim 17, wherein the at least one power constraint comprises a spatial factor that coordinates the activation of the light emitting elements spatially.

20. The system of claim 17, wherein the at least one power constraint comprises a temporal factor that coordinates the activation of the light emitting elements in time.
